(19) United States
(12) Patent Application Publication
(10) Pub. No.: US 2025/0278281 A1
(43) Pub. Date: Sep. 4, 2025

(54) APPLICATION FUNCTION CONFIGURATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Lei MA, Beijing (CN); Yifan Yang, Beijing (CN)

(21) Appl. No.: 19/039,756

(22) Filed: Jan. 28, 2025

(30) Foreign Application Priority Data
Feb. 29, 2024 (CN) 202410233169.5

(51) Int. Cl. G06F 9/445; G06F 8/61; G06F 8/65

(52) U.S. Cl. CPC G06F 9/44526; G06F 8/61; G06F 8/65; G06F 9/4451

(57) ABSTRACT

Embodiments of the present disclosure provide an application function configuration method and apparatus, an electronic device, and a storage medium. An identification plug-in corresponding to a target application is downloaded from an application publishing platform when the target application triggers installation or update, where the identification plug-in is stored in application publishing data of the target application. Client region information is obtained by parsing the identification plug-in, where the client region information is used to indicate a registration region corresponding to a terminal device running the target application. A corresponding target function module is loaded based on the client region information.

### CROSS-REFERENCE TO RELATED APPLICATION

The present application claims priority to Chinese Patent Application No. 202410233169.5, filed on Feb. 29, 2024, which is incorporated herein by reference in its entirety as a part of the present application.

### TECHNICAL FIELD

Embodiments of the present disclosure relate to an application function configuration method and apparatus, an electronic device, and a storage medium.

### BACKGROUND

At present, as global applications are increasing, different functions and services are provided by the global applications in different regions around the world due to factors such as specific local user habits, and laws and regulations. As a result, personalized function modules based on region attributes are usually configured in the applications, to meet operation requirements and user requirements in the corresponding regions.

However, in the prior art, during a process of configuring, by a terminal device, a program function module based on region attributes, there is a problem that the program function module cannot be accurately adapted to an application, affecting normal running of the application.

### SUMMARY

Embodiments of the present disclosure provide an application function configuration method and apparatus, an electronic device, and a storage medium, to solve the problem that an application function module cannot be accurately adapted to an application.

According to a first aspect, an embodiment of the present disclosure provides an application function configuration method. The method includes:
downloading an identification plug-in corresponding to a target application from an application publishing platform when the target application triggers installation or update, where the identification plug-in is stored in application publishing data of the target application; obtaining client region information by parsing the identification plug-in, where the client region information is used to indicate a registration region corresponding to a terminal device running the target application; and loading a corresponding target function module based on the client region information.

According to a second aspect, an embodiment of the present disclosure provides an application function configuration apparatus. The apparatus includes:
an obtaining unit, configured to download an identification plug-in corresponding to a target application from an application publishing platform when the target application triggers installation or update, where the identification plug-in is stored in application publishing data of the target application;
a processing unit, configured to obtain client region information by parsing the identification plug-in, where the client region information is used to indicate a registration region corresponding to a terminal device running the target application; and
a loading unit, configured to load a corresponding target function module based on the client region information.

According to a third aspect, an embodiment of the present disclosure provides an electronic device. The electronic device includes at least one processor and a memory.

The memory stores computer-executable instructions.

The at least one processor executes the computer-executable instructions stored in the memory, so that the application function configuration method according to the first aspect and various possible designs of the first aspect is implemented.

According to a fourth aspect, an embodiment of the present disclosure provides a non-transient computer-readable storage medium having computer-executable instructions stored therein, where the computer-executable instructions, when executed by a processor, cause the application function configuration method according to the first aspect and various possible designs of the first aspect to be implemented.

According to a fifth aspect, an embodiment of the present disclosure provides a computer program product including a computer program. When the computer program is executed by a processor, the application function configuration method according to the first aspect and various possible designs of the first aspect is implemented.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a diagram of an application scenario of an application function configuration method according to an embodiment of the present disclosure;

FIG. 2 is a first schematic flowchart of an application function configuration method according to an embodiment of the present disclosure;

FIG. 3 is a flowchart of an exemplary implementation of step S101 in the embodiment shown in FIG. 2;

FIG. 4 is a schematic diagram of interaction between a terminal device and an application publishing platform according to an embodiment of the present disclosure;

FIG. 5 is a flowchart of an exemplary implementation of step S102 in the embodiment shown in FIG. 2;

FIG. 6 is a flowchart of an exemplary implementation of step S103 in the embodiment shown in FIG. 2;

FIG. 7 is a second schematic flowchart of an application function configuration method according to an embodiment of the present disclosure;

FIG. 8 is a schematic diagram of a process of configuring a function module according to an embodiment of the present disclosure;

FIG. 9 is a block diagram of a structure of an application function configuration apparatus according to an embodiment of the present disclosure;

FIG. 10 is a schematic diagram of a structure of an electronic device according to an embodiment of the present disclosure; and

FIG. 11 is a schematic diagram of a hardware structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All the other embodiments obtained by those of ordinary skill in the art based on the embodiments of the present disclosure without creative efforts shall fall within the scope of protection of the present disclosure.

It should be noted that user information (including but not limited to device information, personal information, and the like of a user) and data (including but not limited to data for analysis, stored data, displayed data, and the like) involved in the present disclosure are information and data for which an authorization is obtained from the user or a full authorization is obtained from each party, and the collection, use, and processing of relevant data need to comply with relevant laws, regulations, and standards in relevant countries and regions, for which corresponding operation entries are provided for the user to choose to authorize or deny.

An application scenario of the embodiments of the present disclosure is described below.

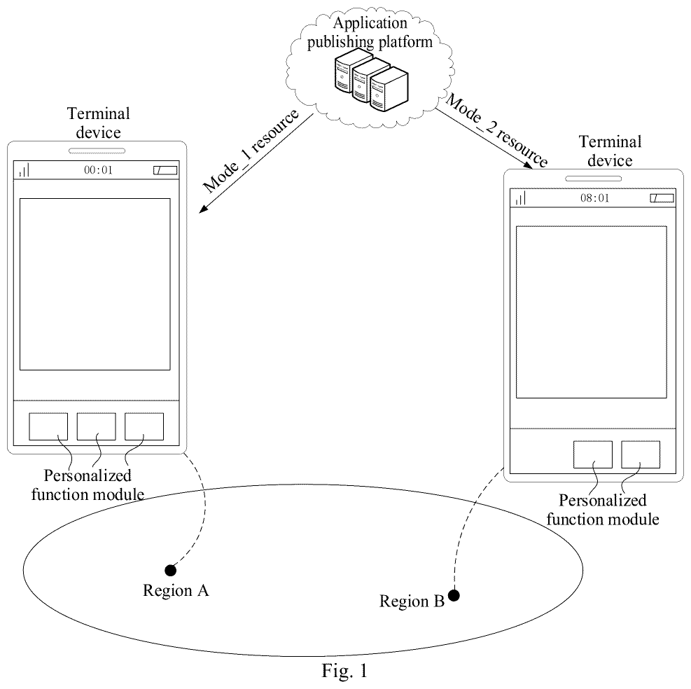

FIG. 1 is a diagram of an application scenario of an application function configuration method according to an embodiment of the present disclosure. The application function configuration method provided in this embodiment of the present disclosure may be applied to an application configuration process before running of an application, including application download, installation, and update processes, that is, an application scenario in which the application is automatically configured. An execution body of this embodiment may be a terminal device running the application, or another electronic device with a similar function. Referring to FIG. 1, a terminal device is used as an example, where the terminal device is, for example, a smartphone shown in the figure. After a client of the application is installed (or updated) on the terminal device, when the application is run for the first time, the terminal device communicates with an application publishing platform over a network, and obtains, from the application publishing platform, a personalized function module resource that is based on a region attribute. For example, a Mode_1 module resource is configured for a terminal device of a region A, and a Mode_2 module resource is configured for a terminal device of a region B. Therefore, the application implements a function for the region attribute.

Alternatively, the method provided in this embodiment may be performed by an application function configuration apparatus. The apparatus may be implemented by software and/or hardware, and may be integrated into an electronic device with a specific data processing function (for example, the terminal device shown in FIG. 1). The electronic device may include, but is not limited to, a mobile terminal with a big data processing capability, and a fixed terminal with a big data processing capability, for example, a desktop computer and a supercomputer.

In the prior art, personalized function modules based on region attributes are usually configured in the applications, to meet operation requirements and user requirements in the corresponding regions. For such an application, region information corresponding to the application usually needs to be first obtained in the prior art. However, location information of a terminal device is user sensitive information, and cannot be directly obtained without access permission. In addition, when the user of the application travels to an infrequently used region, a region corresponding to the location information of the terminal device is inconsistent with a region corresponding to the application conforming to usage habits of the user, which results in a difference between a function module loaded by the application and a function module in the application used by the user in a frequently used region, thereby affecting normal use of the application by the user and degrading the user experience.

An embodiment of the present disclosure provides an application function configuration method, to solve the foregoing problem.

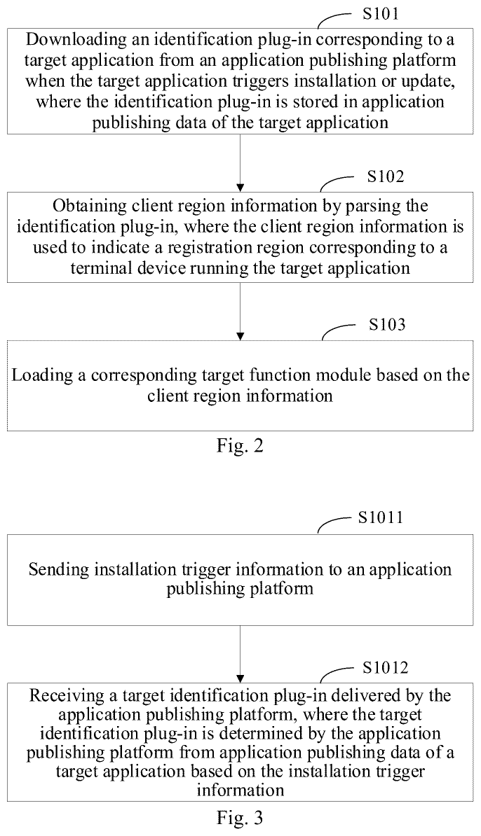

Reference is made to FIG. 2. FIG. 2 is a schematic flowchart 1 of an application function configuration method according to an embodiment of the present disclosure. The method of this embodiment may be applied to a terminal device. The application function configuration method includes the following steps.

Step S101: Downloading an identification plug-in corresponding to a target application from an application publishing platform when the target application triggers installation or update, where the identification plug-in is stored in application publishing data of the target application.

For example, reference is made to the schematic diagram of the application scenario shown in FIG. 1. First, the target application may be various applications capable of loading function modules, for example, an instant messaging application, a video application, and a media editing application. The function modules are functions added to basic functions of the application, for example, an effect function and a sharing function. Such function modules are stored, as resource data, on a server or an application publishing platform corresponding to the application, and may be delivered to the application under a specific trigger condition, to implement loading of the function modules into the application.

In this embodiment, after the target application run on the terminal device triggers installation or update, the terminal device receives the identification plug-in that is sent by the application publishing platform and that corresponds to the target application, where the identification plug-in is stored in the application publishing data of the target application. Specifically, an Android application is used as an example. In a possible implementation, the target application is published to the application publishing platform in the form of an Android App Bundle (AAB), and then the application publishing platform generates a corresponding Android application package (APK) based on the Android App Bundle. In the case that the target application is an Android application, the application publishing data of the target application is an Android App Bundle. One or more identification plug-ins that correspond to the target application and that may be used to indicate different region information are prestored in the Android App Bundle. The identification plug-in is an Android App Bundle-based plug-in (that is, an AAB plug-in), and may be conditionally delivered to the terminal device by the application publishing platform. It should be noted that the above example is an implementation of the target application and the application publishing data under Android, and corresponding implementations under other operating systems may be the same or different. Examples are not numerated herein.

For example, at least two identification plug-ins are prestored in the application publishing data, and the identification plug-in corresponding to the target application is a target identification plug-in. As shown in FIG. 3, a specific implementation of step S101 includes the following steps.

Step S1011: Sending installation trigger information to the application publishing platform.

Step S1012: Receiving the target identification plug-in delivered by the application publishing platform, where the target identification plug-in is determined by the application publishing platform from the application publishing data of the target application based on the installation trigger information.

For example, after the target application triggers an installation or update process, a client of the target application sends the installation trigger information to the application publishing platform. By sending the installation trigger information, the terminal device can obtain installation data or update data of the target application from the application publishing platform, to perform the installation or update process triggered by the target application. After receiving the installation trigger information, the application publishing platform determines a registration region corresponding to the terminal device based on information included in the installation trigger information, for example, an identification identifier, an IP address, and other information of the terminal device. The registration region corresponding to the terminal device may be a region used when an operating system of the terminal device is activated, or may be a region used when an account for the target application is registered via the terminal device. Then, the application publishing platform sends the target identification plug-in corresponding to the registration region of the terminal device to the terminal device through install-time delivery or the like.

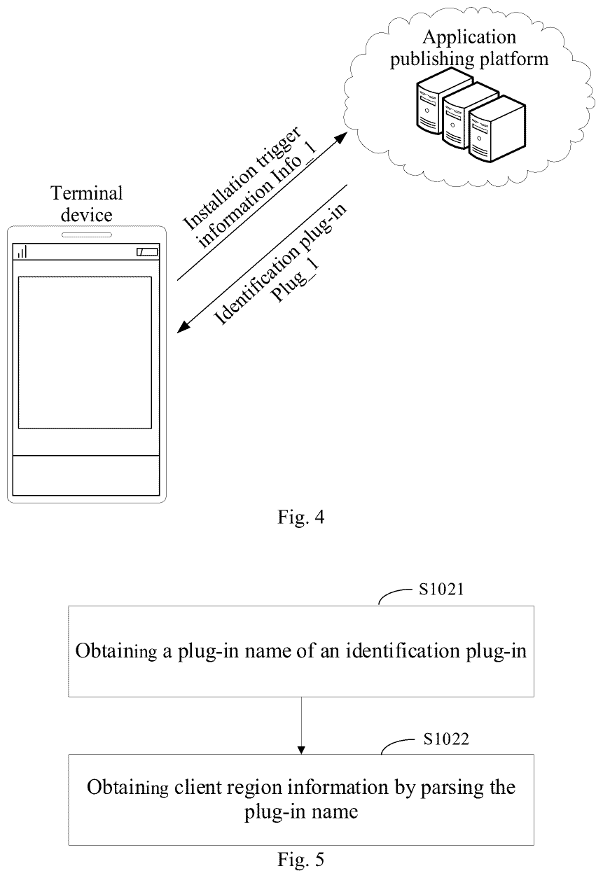

FIG. 4 is a schematic diagram of interaction between the terminal device and the application publishing platform according to an embodiment of the present disclosure. As shown in FIG. 4, after installation or update is triggered, the client of the target application run on the terminal device sends installation trigger information Info_1 to the application publishing platform, where the installation trigger information Info_1 carries related identification information of the terminal device. The application publishing platform determines, based on the installation trigger information Info_1, a registration region addr_1 corresponding to the terminal device, where the registration region addr_1 is, for example, the region used when the operating system of the terminal device is activated, or may be the region used when the account for the target application is registered via the terminal device. Then, the application publishing platform delivers an identification plug-in Plug_1 corresponding to the registration region addr_1 to the terminal device, to complete an interaction process between the terminal device and the application publishing platform.

Since the application publishing platform has higher and more secure permission to access the terminal device, in the steps in this embodiment, region localization is completed for the target application by using the capability of the application publishing platform, and a region localization result is returned to the client of the target application by delivering a plug-in. This not only obtains region information adapting to the target application, but also can ensure the security of user data.

Step S102: Obtaining client region information by parsing the identification plug-in, where the client region information is used to indicate the registration region corresponding to the terminal device running the target application.

For example, after receiving the identification plug-in sent by the application publishing platform, the terminal device parses the identification plug-in to obtain the registration region that corresponds to the terminal device and that is indicated by the identification plug-in, that is, the registration region addr_1 corresponding to the identification plug-in Plug_1 in the embodiment shown in FIG. 4. The registration region is used as the client region information for subsequent loading of function modules. Since the registration region corresponding to the terminal device is usually a frequently used region for a user, configuring a personalized module by using the registration region as a region attribute adapting to the target application can better match a user habit and a need, and improve the running stability of the target application.

Further, for example, as shown in FIG. 5, the identification plug-in is an empty plug-in, and an exemplary implementation of step S102 includes the following steps.

Step S1021: Obtaining a plug-in name of the identification plug-in.

Step S1022: Obtaining the client region information by parsing the plug-in name.

For example, in a possible implementation, the identification plug-in prestored in the application publishing data is an empty plug-in, that is, a plug-in file including no specific executable code. Therefore, the identification plug-in prestored in the application publishing data is small in volume, and even if there are included a plurality of identification plug-ins corresponding to different registration regions, the amount of data downloaded for the target application is not affected.

In a possible implementation, the terminal device stores the identification plug-in to an exemplary location upon receiving the identification plug-in. Then, after detecting the presence of a file at the specific location, the terminal device reads a file name of the file, to obtain the plug-in name. Then, the plug-in name is parsed according to a preset rule, to generate the corresponding client region information. According to the steps in this embodiment, beneficial effects of improving the processing efficiency and reducing resource occupation can be achieved.

Step S103: Loading a corresponding target function module based on the client region information.

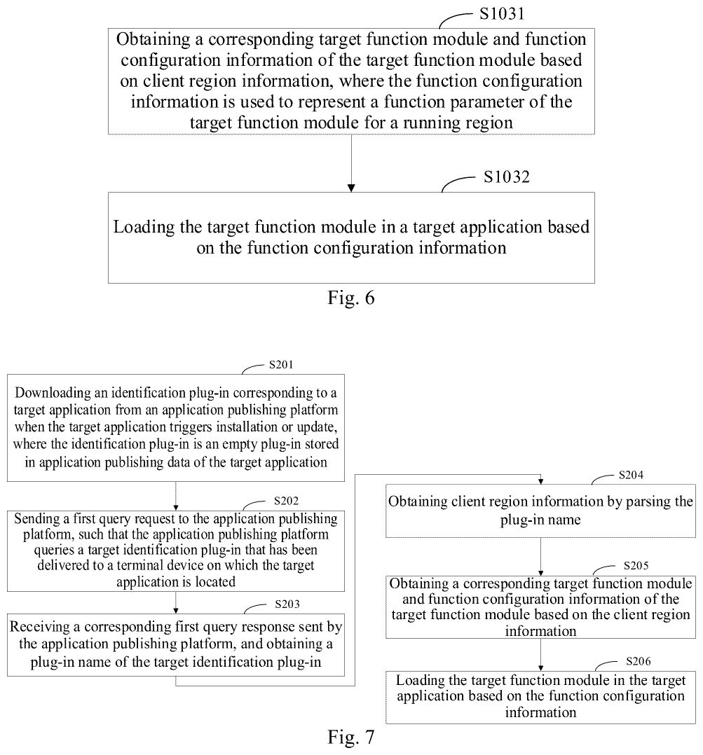

For example, the terminal device maps the client region information to the corresponding target function module, and loads the corresponding target function module, to complete a personalized function module loading process. In a possible implementation, for example, as shown in FIG. 6, an exemplary implementation of step S103 includes the following steps.

Step S1031: Obtaining the corresponding target function module and function configuration information of the target function module based on the client region information, where the function configuration information is used to represent a function parameter of the target function module for a running region.

Step S1032: Loading the target function module in the target application based on the function configuration information.

For example, first, the client region information may be a specific region identifier, for example, US or addr_1. Then, the terminal device obtains resource data corresponding to the region identifier locally or from a server based on the region identifier, where the resource data includes the target function module and the function configuration information corresponding to the target function module, and the function configuration information is used to represent the function parameter of the target function module for the running region, for example, screen brightness corresponding to a camera effect (the target function module) (when the camera effect is run, a screen may be used as a supplementary light source). Then, the terminal device loads the target function module into the target application, for example, the camera effect in the above example, and configures the target function module based on the function configuration information, for example, sets the screen brightness corresponding to the camera effect in the above example, to implement function setting for the target function module.

In this embodiment, the terminal device obtains the corresponding target function module and the corresponding function configuration information based on the client region information, and loads and configures the target function module based on the function configuration information. In this way, an application function provided by the target function module is controlled more specifically, so that application functions are configured more accurately based on region attributes, and the user experience and the running stability of the application are improved.

Further, an exemplary implementation of step S1032 includes the following steps.

Step S1032A: Obtaining, from the application publishing platform based on the client region information, at least one function module to be loaded that corresponds to the client region information, and displaying the at least one function module to be loaded.

Step S1032B: Determining and loading the target function module in the at least one function module to be loaded, in response to a user operation.

In a possible implementation, the client region information corresponds to a plurality of function modules to be loaded. After obtaining the client region information, the terminal device may obtain a plurality of corresponding function modules to be loaded from the application publishing platform based on the client region information, and display the plurality of corresponding function modules to be loaded. Then, the terminal device selects, in response to a selection operation of the user, one or more of the plurality of function modules to be loaded as the target function module, and loads the target function module. Still further, in another possible implementation, the user may further set and select, based on the above embodiment, function configuration information corresponding to the function module to be loaded. The terminal device determines a function module to be loaded indicated by the user operation and corresponding function configuration information, in response to a user operation, and then determines and loads the target function module and the corresponding function configuration information. According to the steps in the embodiment, a personalized function module meeting a user requirement better can be loaded, which improves the user experience.

In this embodiment, the identification plug-in corresponding to the target application is downloaded from the application publishing platform when the target application triggers installation or update, where the identification plug-in is stored in the application publishing data of the target application. The client region information is obtained by parsing the identification plug-in, where the client region information is used to indicate the registration region corresponding to the terminal device running the target application. The corresponding target function module is loaded based on the client region information. The prestored identification plug-in is downloaded from the application publishing platform, the registration region corresponding to the terminal device running the target application is identified by using the capability of the application publishing platform, and then the target function module corresponding to the registration region is determined and loaded. In this way, the loaded target function module can be accurately adapted to the target application, thus improving stability and availability of the target application.

Reference is made to FIG. 7, which is a second schematic flowchart of an application function configuration method according to an embodiment of the present disclosure. In this embodiment, steps S102 and S103 are further detailed based on the embodiment shown in FIG. 2. The application function configuration method includes the following steps.

Step S201: Downloading an identification plug-in corresponding to a target application from an application publishing platform when the target application triggers installation or update, where the identification plug-in is an empty plug-in stored in application publishing data of the target application.

For example, after a terminal device downloads the identification plug-in corresponding to the target application from the application publishing platform, with reference to the descriptions of the steps in the embodiment shown in FIG. 5 in the embodiment shown in FIG. 2, the terminal device may parse the identification plug-in locally, to obtain a plug-in name, thereby obtaining client region information. In order to further improve the security and the confidentiality of user data and reduce information processing steps performed locally by a client of the target application at the terminal device, in this embodiment, the terminal device obtains the plug-in name by sending a request to the application publishing platform.

Step S202: Sending a first query request to the application publishing platform, such that the application publishing platform queries a target identification plug-in that has been delivered to the terminal device on which the target application is located.

Step S203: Receiving a corresponding first query response sent by the application publishing platform, and obtaining a plug-in name of the target identification plug-in.

For example, the terminal device first sends the first query request to the application publishing platform. This process may be implemented by invoking an application interface (API) provided by the application publishing platform. A specific implementation of the first query request is determined based on the application interface provided by the application publishing platform, which is not limited herein. After receiving the first query request, the application publishing platform queries, in response to the first query request, a related record of an identification plug-in that has been delivered to the target application corresponding to the terminal device, to obtain a plug-in identifier representing the identification plug-in that has been delivered to the target application, and returns the plug-in identifier to the terminal device, that is, the first query response. The plug-in identifier may be included in the first query response. Then, the terminal device obtains the plug-in identifier based on the first query response, and then parses the plug-in identifier to obtain a plug-in name.

In this embodiment, the plug-in name of the identification plug-in is obtained by sending the first query request to the application publishing platform, so that the security and the confidentiality of the user data are further improved, and the problem of unstable running of the target application due to interception of a permission management system is avoided.

Further, optionally, before step S202, the method further includes the following steps.

Step S202A: Obtaining a preset plug-in name sequence, where the plug-in name sequence includes at least one ordered plug-in name to be queried.

Step S202B: Generating the first query request based on the plug-in name sequence, where the first query request is used to instruct the application publishing platform to query each plug-in name to be queried in sequence based on the plug-in name sequence, to determine the plug-in name of the target identification plug-in.

For example, in a possible implementation, based on a specific implementation of the API provided by the application publishing platform, the first query request needs to include the plug-in name to be queried, to instruct the application publishing platform to query the plug-in name to be queried to determine the plug-in name of the identification plug-in that has been delivered by the application publishing platform to the target application. In other words, the application publishing platform does not provide or directly deliver the plug-in name of the identification plug-in that has been delivered to the target application. In this case, the client of the target application needs to cyclically send a plurality of plug-in names to be queried to the application publishing platform, and the application publishing platform detects each plug-in name to be queried in sequence, and returns a detection result. For example, if an identification plug-in corresponding to the plug-in name to be queried has been delivered, 1 is returned; or if an identification plug-in corresponding to the plug-in name to be queried has not been delivered, 0 is returned.

In this case, in this embodiment, the terminal device first obtains the plug-in name sequence, where the plug-in name sequence is a set of ordered plug-in names. The following is an example of the plug-in name sequence: pluglist=[Plug_1, Plug_2 . . . , Plug_3]. The plug-in name sequence is information preset in the client of the target application. The plug-in names to be queried in the plug-in name sequence are sorted based on, for example, the numbers of registered users in different regions. For example, if there are most registered users in an addr_1 region, an identification plug-in Plug_1 indicating the addr_1 region is arranged at the first place in the plug-in name sequence. By parity of reasoning, the plug-in name sequence is formed. Certainly, the plug-in name sequence may alternatively be formed in another manner, for example, is formed by sorting based on the numbers of active users in different regions. This may be set as needed. Details are not described with examples herein again. Then, the first query request is generated based on the plug-in name sequence, and is sent to the application publishing platform, so that the application publishing platform can query each plug-in name to be queried in sequence according to a query order indicated by the plug-in name sequence, until the plug-in identifier of the identification plug-in delivered to the target application is obtained. In the steps in this embodiment, since the plug-in names to be queried are arranged by probability, time consumption of the application publishing platform in finding the plug-in identifier of the identification plug-in delivered to the target application can be reduced, and the efficiency in obtaining the plug-in name can be improved.

Step S204: Obtaining the client region information by parsing the plug-in name.

Step S205: Obtaining a corresponding target function module and function configuration information of the target function module based on the client region information.

Step S206: Loading the target function module in the target application based on the function configuration information.

For example, the target function module includes a camera effect function module and/or a sharing function module, and the function configuration information includes first configuration information for the camera effect function module and/or second configuration information for the sharing function module. The first configuration information represents screen brightness of the terminal device during running of the camera effect function module. The second configuration information represents a display order of a sharing channel during running of the sharing function module.

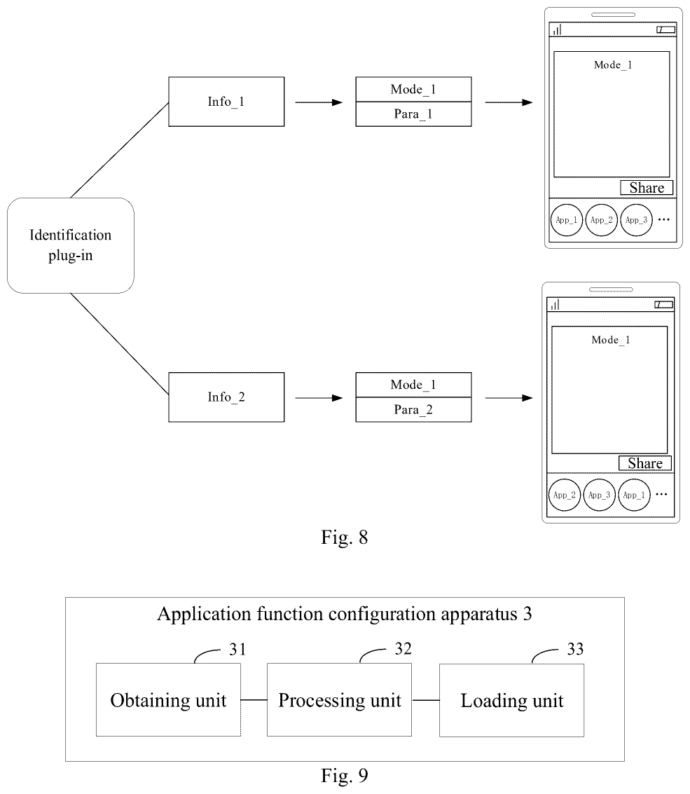

The above steps are described below with an exemplary embodiment. FIG. 8 is a schematic diagram of a process of configuring a function module according to an embodiment of the present disclosure. As shown in FIG. 8, for example, in a possible case, after the terminal device obtains client region information Info_1 indicating a registration region corresponding to the terminal device running the target application, the terminal device determines a corresponding effect function module Mode_1 and configuration information Para_1 corresponding to the effect function module Mode_1 based on the client region information Info_1. The effect function module Mode_1 may be used to add an effect to a video or an image, to generate special-effect media, and share the generated special-effect media to third-party applications. The configuration information Para_1 is used to determine an order of the third-party applications on a page, that is, a display order. As shown in the figure, the order of the third-party applications determined based on the configuration information Para_1 is App_1, App_2, and App_3. In another possible case, after the terminal device obtains client region information Info_2 indicating a registration region corresponding to the terminal device running the target application, the terminal device determines a corresponding effect function module Mode_1 and configuration information Para_2 corresponding to the effect function module Mode_1 based on the client region information Info_2. The effect function module Mode_1 is the same as that in the previous case, and is configured to share, to third-party applications, a special-effect picture generated based on the camera effect function module. The configuration information Para_2 is used to determine an order of the third-party applications on a page. As shown in the figure, the order of the third-party applications determined based on the configuration information Para_2 is App_2, App_3, and App_1. In other words, the display order of the third-party applications in the effect function module Mode_1 changes. In an effect function module loaded based on a region attribute, since popularities of various third-party applications are different depending on regions, a display order of sharing channels in the effect function module is further configured based on the determined client region information when the effect function module is loaded, which can further improve the efficiency in sharing the special-effect media generated in the effect function module and the availability of the sharing channels, and improve the user experience.

In this embodiment, an implementation of step S201 is the same as that of step S101 in the embodiment shown in FIG. 2 in the present disclosure, and details are not described herein again.

Corresponding to the application function configuration method of the above embodiment, FIG. 9 is a block diagram of a structure of an application function configuration apparatus according to an embodiment of the present disclosure. For ease of description, only parts related to this embodiment of the present disclosure are shown. Referring to FIG. 9, the application function configuration apparatus 3 includes:
an obtaining unit 31, configured to download an identification plug-in corresponding to a target application from an application publishing platform when the target application triggers installation or update, where the identification plug-in is stored in application publishing data of the target application;
a processing unit 32, configured to obtain client region information by parsing the identification plug-in, where the client region information is used to indicate a registration region corresponding to a terminal device running the target application; and
a loading unit 33, configured to load a corresponding target function module based on the client region information.

According to one or more embodiments of the present disclosure, the processing unit 32 may be configured to: obtain a plug-in name of the identification plug-in; and obtain the client region information by parsing the plug-in name.

According to one or more embodiments of the present disclosure, when obtaining the plug-in name of the identification plug-in, the processing unit 32 may be configured to: send a first query request to the application publishing platform, such that the application publishing platform queries a target identification plug-in that has been delivered to the terminal device on which the target application is located; and receive a corresponding first query response sent by the application publishing platform, and obtain a plug-in name of the target identification plug-in.

According to one or more embodiments of the present disclosure, the processing unit 32 is further configured to: obtain a preset plug-in name sequence, where the plug-in name sequence includes at least one ordered plug-in name to be queried; and generate the first query request based on the plug-in name sequence, where the first query request is used to instruct the application publishing platform to query each plug-in name to be queried in sequence based on the plug-in name sequence, to determine the plug-in name of the target identification plug-in.

According to one or more embodiments of the present disclosure, the obtaining unit 31 may be configured to: send installation trigger information to the application publishing platform; and receive a target identification plug-in delivered by the application publishing platform, where the target identification plug-in is determined by the application publishing platform from the application publishing data of the target application based on the installation trigger information.

According to one or more embodiments of the present disclosure, the loading unit 33 may be configured to: obtain the corresponding target function module and function configuration information of the target function module based on the client region information, where the function configuration information is used to represent a function parameter of the target function module for a running region; and load the target function module in the target application based on the function configuration information.

According to one or more embodiments of the present disclosure, the target function module includes an effect function module, the function configuration information includes configuration information for the effect function module, and the configuration information is used to determine a display order of a sharing channel in the effect function module.

According to one or more embodiments of the present disclosure, when loading the target function module in the target application based on the function configuration information, the loading unit 33 may be configured to: obtain, from the application publishing platform based on the client region information, at least one function module to be loaded that corresponds to the client region information, and display the at least one function module to be loaded; and determine and load the target function module in the at least one function module to be loaded, in response to a user operation.

The obtaining unit 31, the processing unit 32, and the loading unit 33 are connected in sequence. The application function configuration apparatus 3 provided in this embodiment may perform the technical solution of the above method embodiment, with similar implementation principles and technical effects. Details are not described in this embodiment again.

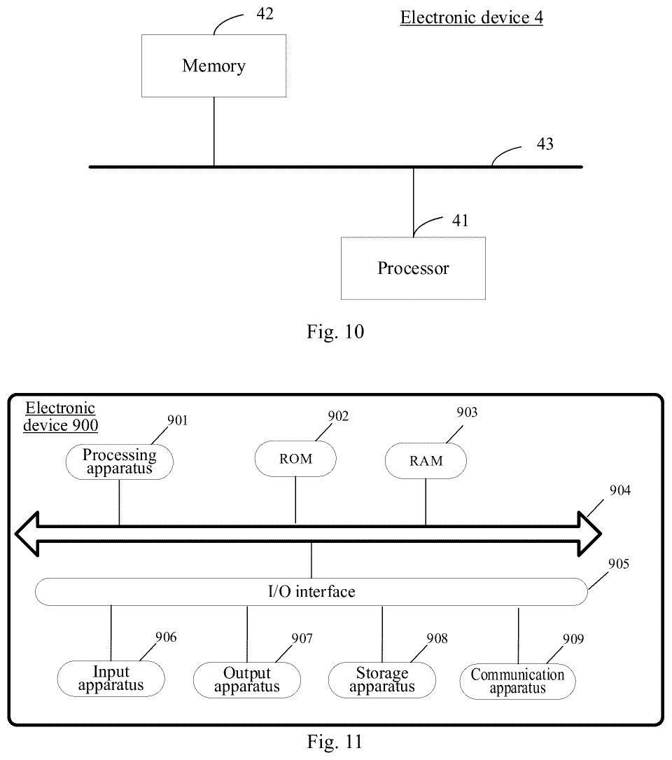

FIG. 10 is a schematic diagram of a structure of an electronic device according to an embodiment of the present disclosure. As shown in FIG. 10, the electronic device 4 includes:
a processor 41, and a memory 42 in communicative connection to the processor 41.

The memory 42 stores computer-executable instructions.

The processor 41 executes the computer-executable instructions stored in the memory 42, to implement the application function configuration method in the embodiments shown in FIG. 2 to FIG. 8.

Optionally, the processor 41 and the memory 42 are connected through a bus 43.

Related descriptions may be understood by correspondingly referring to the related descriptions and effects corresponding to the steps in the embodiments corresponding to FIG. 2 to FIG. 8. Details are not described herein again.

An embodiment of the present disclosure provides a computer-readable storage medium storing computer-executable instructions that, when executed by a processor, are configured to implement the application function configuration method provided in any one of the embodiments corresponding to FIG. 2 to FIG. 8 in the present disclosure.

An embodiment of the present disclosure provides a computer program product including a computer program. When the computer program is executed by a processor, the application function configuration method provided in any one of the embodiments corresponding to FIG. 2 to FIG. 8 is implemented.

To implement the above embodiments, an embodiment of the present disclosure further provides an electronic device.

FIG. 11 is a schematic diagram of a structure of an electronic device 900 suitable for implementing an embodiment of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 11 is merely an example, and shall not impose any limitation on the function and scope of use of the embodiments of the present disclosure.

As shown in FIG. 11, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random-access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a magnetic tape and a hard disk; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 909 and installed, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units or modules described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, there is provided an application function configuration method. The method includes:
downloading an identification plug-in corresponding to a target application from an application publishing platform when the target application triggers installation or update, where the identification plug-in is stored in application publishing data of the target application; obtaining client region information by parsing the identification plug-in, where the client region information is used to indicate a registration region corresponding to a terminal device running the target application; and loading a corresponding target function module based on the client region information.

According to one or more embodiments of the present disclosure, the identification plug-in is an empty plug-in. The obtaining client region information by parsing the identification plug-in includes: obtaining a plug-in name of the identification plug-in; and obtaining the client region information by parsing the plug-in name.

According to one or more embodiments of the present disclosure, the obtaining a plug-in name of the identification plug-in includes: sending a first query request to the application publishing platform, such that the application publishing platform queries a target identification plug-in that has been delivered to the terminal device on which the target application is located; and receiving a corresponding first query response sent by the application publishing platform, and obtaining a plug-in name of the target identification plug-in.

According to one or more embodiments of the present disclosure, the method further includes: obtaining a preset plug-in name sequence, where the plug-in name sequence includes at least one ordered plug-in name to be queried; and generating the first query request based on the plug-in name sequence, where the first query request is used to instruct the application publishing platform to query each plug-in name to be queried in sequence based on the plug-in name sequence, to determine the plug-in name of the target identification plug-in.

According to one or more embodiments of the present disclosure, at least two identification plug-ins are prestored in the application publishing data. The downloading an identification plug-in corresponding to a target application from an application publishing platform when the target application triggers installation or update includes: sending installation trigger information to the application publishing platform; and receiving a target identification plug-in delivered by the application publishing platform, where the target identification plug-in is determined by the application publishing platform from the application publishing data of the target application based on the installation trigger information.

According to one or more embodiments of the present disclosure, the loading a corresponding target function module based on the client region information includes: obtaining the corresponding target function module and function configuration information of the target function module based on the client region information, where the function configuration information is used to represent a function parameter of the target function module for a running region; and loading the target function module in the target application based on the function configuration information.

According to one or more embodiments of the present disclosure, the target function module includes an effect function module, the function configuration information includes configuration information for the effect function module, and the configuration information is used to determine a display order of a sharing channel in the effect function module.

According to one or more embodiments of the present disclosure, the loading the target function module in the target application based on the function configuration information includes: obtaining, from the application publishing platform based on the client region information, at least one function module to be loaded that corresponds to the client region information, and displaying the at least one function module to be loaded; and determining and loading the target function module in the at least one function module to be loaded, in response to a user operation.

In a second aspect, according to one or more embodiments of the present disclosure, there is provided an application function configuration apparatus. The apparatus includes:
an obtaining unit, configured to download an identification plug-in corresponding to a target application from an application publishing platform when the target application triggers installation or update, where the identification plug-in is stored in application publishing data of the target application;
a processing unit, configured to obtain client region information by parsing the identification plug-in, where the client region information is used to indicate a registration region corresponding to a terminal device running the target application; and
a loading unit, configured to load a corresponding target function module based on the client region information.

According to one or more embodiments of the present disclosure, the processing unit may be configured to: obtain a plug-in name of the identification plug-in; and obtain the client region information by parsing the plug-in name.

According to one or more embodiments of the present disclosure, when obtaining the plug-in name of the identification plug-in, the processing unit may be configured to: send a first query request to the application publishing platform, such that the application publishing platform queries a target identification plug-in that has been delivered to the terminal device on which the target application is located; and receive a corresponding first query response sent by the application publishing platform, and obtain a plug-in name of the target identification plug-in.

According to one or more embodiments of the present disclosure, the processing unit is further configured to: obtain a preset plug-in name sequence, where the plug-in name sequence includes at least one ordered plug-in name to be queried; and generate the first query request based on the plug-in name sequence, where the first query request is used to instruct the application publishing platform to query each plug-in name to be queried in sequence based on the plug-in name sequence, to determine the plug-in name of the target identification plug-in.

According to one or more embodiments of the present disclosure, the obtaining unit may be configured to: send installation trigger information to the application publishing platform; and receive a target identification plug-in delivered by the application publishing platform, where the target identification plug-in is determined by the application publishing platform from the application publishing data of the target application based on the installation trigger information.

According to one or more embodiments of the present disclosure, the loading unit may be configured to: obtain the corresponding target function module and function configuration information of the target function module based on the client region information, where the function configuration information is used to represent a function parameter of the target function module for a running region; and load the target function module in the target application based on the function configuration information.

According to one or more embodiments of the present disclosure, the target function module includes an effect function module, the function configuration information includes configuration information for the effect function module, and the configuration information is used to determine a display order of a sharing channel in the effect function module.

According to one or more embodiments of the present disclosure, when loading the target function module in the target application based on the function configuration information, the loading unit may be configured to: obtain, from the application publishing platform based on the client region information, at least one function module to be loaded that corresponds to the client region information, and display the at least one function module to be loaded; and determine and load the target function module in the at least one function module to be loaded, in response to a user operation.

In a third aspect, according to one or more embodiments of the present disclosure, there is provided an electronic device. The electronic device includes at least one processor and a memory.

The memory stores computer-executable instructions.

The at least one processor executes the computer-executable instructions stored in the memory, so that the application function configuration method according to the first aspect and various possible designs of the first aspect is implemented.

In a fourth aspect, according to one or more embodiments of the present disclosure, there is provided a computer-readable storage medium having computer-executable instructions stored therein, where the computer-executable instructions, when executed by a processor, cause the application function configuration method according to the first aspect and various possible designs of the first aspect to be implemented.

In a fifth aspect, according to one or more embodiments of the present disclosure, there is provided a computer program product including a computer program. When the computer program is executed by a processor, the application function configuration method according to the first aspect and various possible designs of the first aspect is implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An application function configuration method, comprising:
downloading an identification plug-in corresponding to a target application from an application publishing platform in response to the target application triggering installation or update, wherein the identification plug-in is stored in application publishing data of the target application;
obtaining client region information by parsing the identification plug-in, wherein the client region information is used to indicate a registration region corresponding to a terminal device running the target application; and
loading a corresponding target function module based on the client region information.

2. The method according to claim 1, wherein the identification plug-in is an empty plug-in, and wherein obtaining the client region information by parsing the identification plug-in comprises:
obtaining a plug-in name of the identification plug-in; and
obtaining the client region information by parsing the plug-in name.

3. The method according to claim 2, wherein obtaining the plug-in name of the identification plug-in comprises:
sending a first query request to the application publishing platform, such that the application publishing platform queries a target identification plug-in that has been delivered to the terminal device on which the target application is located; and
receiving a corresponding first query response sent by the application publishing platform, and obtaining a plug-in name of the target identification plug-in.

4. The method according to claim 3, further comprising:
obtaining a preset plug-in name sequence, wherein the plug-in name sequence comprises at least one ordered plug-in name to be queried; and
generating the first query request based on the plug-in name sequence, wherein the first query request is used to instruct the application publishing platform to query each plug-in name to be queried in sequence based on the plug-in name sequence, to determine the plug-in name of the target identification plug-in.

5. The method according to claim 1, wherein at least two identification plug-ins are prestored in the application publishing data; and downloading the identification plug-in corresponding to the target application from the application publishing platform in response to the target application triggering the installation or the update comprises:
sending installation trigger information to the application publishing platform; and
receiving a target identification plug-in delivered by the application publishing platform, wherein the target identification plug-in is determined by the application publishing platform from the application publishing data of the target application based on the installation trigger information.

6. The method according to claim 1, wherein loading the corresponding target function module based on the client region information comprises:
obtaining the corresponding target function module and function configuration information of the target function module based on the client region information, wherein the function configuration information is used to represent a function parameter of the target function module for a running region; and
loading the target function module in the target application based on the function configuration information.

7. The method according to claim 6, wherein the target function module comprises an effect function module, the function configuration information comprises configuration information for the effect function module, and the configuration information for the effect function module is used to determine a display order of a sharing channel in the effect function module.

8. The method according to claim 6, wherein loading the target function module in the target application based on the function configuration information comprises:
obtaining, from the application publishing platform based on the client region information, at least one function module to be loaded that corresponds to the client region information, and displaying the at least one function module to be loaded; and
determining and loading the target function module in the at least one function module to be loaded, in response to a user operation.

9. An electronic device, comprising: at least one processor and a memory, wherein
the memory stores computer-executable instructions; and
the at least one processor executes the computer-executable instructions stored in the memory, so that an application function configuration method is implemented, comprising:
downloading an identification plug-in corresponding to a target application from an application publishing platform in response to the target application triggering installation or update, wherein the identification plug-in is stored in application publishing data of the target application;
obtaining client region information by parsing the identification plug-in, wherein the client region information is used to indicate a registration region corresponding to a terminal device running the target application; and
loading a corresponding target function module based on the client region information.

10. The electronic device according to claim 9, wherein in the application function configuration method,
the identification plug-in is an empty plug-in, and obtaining the client region information by parsing the identification plug-in comprises:
obtaining a plug-in name of the identification plug-in; and
obtaining the client region information by parsing the plug-in name.

11. The electronic device according to claim 10, wherein in the application function configuration method,
obtaining the plug-in name of the identification plug-in comprises:
sending a first query request to the application publishing platform, such that the application publishing platform queries a target identification plug-in that has been delivered to the terminal device on which the target application is located; and
receiving a corresponding first query response sent by the application publishing platform, and obtaining a plug-in name of the target identification plug-in.

12. The electronic device according to claim 11, wherein the application function configuration method further comprises:
obtaining a preset plug-in name sequence, wherein the plug-in name sequence comprises at least one ordered plug-in name to be queried; and
generating the first query request based on the plug-in name sequence, wherein the first query request is used to instruct the application publishing platform to query each plug-in name to be queried in sequence based on the plug-in name sequence, to determine the plug-in name of the target identification plug-in.

13. The electronic device according to claim 9, wherein in the application function configuration method,
at least two identification plug-ins are prestored in the application publishing data; and downloading the identification plug-in corresponding to the target application from the application publishing platform in response to the target application triggering the installation or the update comprises:
sending installation trigger information to the application publishing platform; and
receiving a target identification plug-in delivered by the application publishing platform, wherein the target identification plug-in is determined by the application publishing platform from the application publishing data of the target application based on the installation trigger information.

14. The electronic device according to claim 9, wherein in the application function configuration method, loading the corresponding target function module based on the client region information comprises:
obtaining the corresponding target function module and function configuration information of the target function module based on the client region information, wherein the function configuration information is used to represent a function parameter of the target function module for a running region; and
loading the target function module in the target application based on the function configuration information.

15. The electronic device according to claim 14, wherein in the application function configuration method,
the target function module comprises an effect function module, the function configuration information comprises configuration information for the effect function module, and the configuration information for the effect function module is used to determine a display order of a sharing channel in the effect function module.

16. The electronic device according to claim 14, wherein in the application function configuration method,
loading the target function module in the target application based on the function configuration information comprises:
obtaining, from the application publishing platform based on the client region information, at least one function module to be loaded that corresponds to the client region information, and displaying the at least one function module to be loaded; and
determining and loading the target function module in the at least one function module to be loaded, in response to a user operation.

17. A non-transient computer-readable storage medium, having computer-executable instructions stored therein, wherein the computer-executable instructions, when executed by a processor, cause an application function configuration method to be implemented, comprising:
downloading an identification plug-in corresponding to a target application from an application publishing platform in response to the target application triggering installation or update, wherein the identification plug-in is stored in application publishing data of the target application;
obtaining client region information by parsing the identification plug-in, wherein the client region information is used to indicate a registration region corresponding to a terminal device running the target application; and
loading a corresponding target function module based on the client region information.
